(19) United States
(12) Patent Application Publication
(10) Pub. No.: US 2006/0006999 A1
(43) Pub. Date: Jan. 12, 2006

(54) Monitoring people, objects, and information using radio frequency identification

(75) Inventors: Barbara Walczyk, Franklin, TN (US); Neal Patel, Nashville, TN (US); John Hobby, Nashville, TN (US); James Burgess III, Oklahoma City, OK (US)

Correspondence Address: FULBRIGHT & JAWORSKI L.L.P., 600 CONGRESS AVE., SUITE 2400, AUSTIN, TX, 78701, US

(73) Assignee: Vanderbilt University

(21) Appl. No.: 11/040,496

(22) Filed: Jan. 21, 2005

Related U.S. Application Data
(60) Provisional application No. 60/538,412, filed on Jan. 22, 2004.
(60) Provisional application No. 60/545,328, filed on Feb. 17, 2004.

(51) Int. Cl. G08B 1/08; G08B 13/14; G08C 19/12

(52) U.S. Cl. 340/539.27; 340/572.1; 340/870.17

(57) ABSTRACT

Techniques for monitoring temperature inside refrigerators or heaters and tracking people and/or objects, particularly within a medical setting. For temperature monitoring, temperature readings are obtained using a temperature monitor. The temperature readings are transmitted from a radio frequency identification (RFID) tag to an RFID reader. The temperature readings received by the RFID reader are then monitored as a function of time. For tracking people or objects, RFID tags are attached to the people or objects, a facility is equipped with one or more RFID readers, and activity of the people or objects is monitored.

This application claims priority to, and incorporates by reference, (a) U.S. Provisional Patent Application Ser. No. 60/538,412 filed Jan. 22, 2004 and (b) U.S. Provisional Patent Application Ser. No. 60/545,328 filed Feb. 17, 2004.

### BACKGROUND OF THE INVENTION

1. Field of the Invention

The present invention relates generally to radio frequency identification (RFID) techniques to accomplish several tasks. In preferred embodiments, the RFID applications take place in a medical setting such as a hospital and include refrigerator temperature monitoring. Additional preferred embodiments include people tracking and monitoring, medical error reduction, time and motion analyses, and asset tracking and inventory maintenance.

2. Description of Related Art

Temperature Monitoring

Currently in the healthcare industry, refrigerators are used to store several items and substances, like for example, specimens, blood, drugs, breast milk, food, etc. To monitor the temperature inside these refrigerators, it is common that every 12 to 24 hours a person manually checks the temperature inside the refrigerator and records this temperature in a log. Some states issue citations if a hospital does not keep current and complete logs. Manually completing these logs can be arduous and time-consuming. In addition, since the temperature only gets checked once or twice per day, one cannot know whether the temperature fell or rose outside acceptable levels in between the checking times. This uncertainty leads to vulnerabilities, including potential decomposing or perishing of the substances and items inside the refrigerator during the unchecked periods, and consequential health risks to patients. Increasing the number of times the temperature gets manually checked would add an unwanted burden.

People Tracking and Monitoring

Currently in the healthcare industry, tracking and monitoring options range from open access to restricted access through a variety of methods. Non-healthcare persons such as patients and visitors are usually given identification (ID) bands or badges that allow them restricted access or access only to specified areas. Healthcare persons are issued ID badges which may include an access mechanism allowing them entry into restricted areas depending on their job role. However, continual tracking or monitoring through a system such as this is not easily possible for a variety of reasons. Infiltration to restricted areas by individuals can easily occur and identification of such breaches poses an additional burden on security staff using additional resources. The lack of a notification mechanism leads to certain vulnerabilities including potential harm of patient or property through theft, patient abduction, etc. These are some of the many reasons why a simple system of band or badge tracking is insufficient.

Medical Error Reduction

Medication errors present a major concern for all healthcare providers. Recently, great strides have been taken to reduce the number of errors that occur during the time of physician ordering, the step in the medication system at which errors occur most frequently. Improvements in the reduction of potential adverse drug events (ADE) have been accomplished through use of Computerized Physician Order Entry (CPOE) systems. However, providers are now realizing that drug administration is also a process during which an ADE is likely to occur.

Currently, in addition to CPOE, the approach taken to decrease medication administration errors involves two nurse checks of medications in conjunction with two checks of patient identification. The concept of using barcode technology to correlate medications with patient identity provides some degree of defense against medication errors but ultimately relies upon the manual process of the patient care provider scanning each barcode; a system that can be bypassed with no alert given to central systems. Accordingly, improvements are needed.

Time and Motion Analyses

Currently for quality improvement projects, information is needed regarding time spent in a location and transit times for patients, visitors, or others. Significant effort is required by the individual recording such data which often results in constraints on the amount of data that can be collected before decisions can be made or processes can be evaluated. Accordingly, improvements are needed.

Asset Tracking and Inventory Maintenance

Asset tracking and inventory maintenance is currently a manual task that uses resources and wastes budgetary dollars. The maintenance of assets has significant clinical impact regarding a lack of availability of both supplies and equipment and the decontamination of supplies and equipment.

Manual asset tracking and inventory maintenance results in reduced quality of care and reduced provider and patient satisfaction. Inefficient ordering and over-ordering of supplies have both strong financial and clinical impacts for any organization. In addition to this, hoarding of equipment often occurs due to the variability of ability to secure clinical equipment and supplies. As a result, restocking, reordering, and replacing processes are inefficient. Because assets and equipment tracking is currently a manual process there is an overall lack of security leading to loss of supplies and equipment through both malicious and non-malicious intent. This loss results in a waste of capital which in turn negatively impacts the operating budget of an organization.

Barcode technology has been used in hospitals as a system for tracking supplies and equipment. Such systems, however, are still heavily dependent on a human interface to catalogue all the items and check them in and out as they move though the organization. Accordingly, improvements are needed.

These referenced shortcomings of conventional methodologies are not intended to be exhaustive, but rather are among many that tend to impair the effectiveness of previously known techniques for the tasks mentioned above. Other noteworthy problems may also exist; however, those mentioned here are sufficient to demonstrate that methodology and apparatuses appearing in the art have not been altogether satisfactory and that a significant need exists for techniques described and claimed here.

### SUMMARY OF THE INVENTION

Certain shortcomings of the prior art may be reduced or eliminated by the techniques disclosed here. These techniques are applicable to a vast number of applications, including applications that monitor temperature inside refrigerators or heaters and generally track people and/or objects. In preferred embodiments, the techniques are tailored for a medical setting, such as within a hospital although it will be understood by those having ordinary skill in the art that different settings may utilize and benefit from the invention equally well.

In one respect, the invention involves a method for monitoring the temperature inside a refrigerator or heater. Temperature readings are obtained from within a refrigerator or heater using a temperature monitor. The temperature readings are transmitted from an RFID tag to an RFID reader. The temperature readings received by the RFID reader are monitored as a function of time. Monitoring “as a function of time” refers to monitoring done over a time period so that one can determine temporal temperature trends. Monitoring “as a function of time” does not necessarily require a time stamp associated with individual temperature readings, although such stamping may be done. Monitoring can include recording temperature readings in an electronic log. Monitoring can include continuous monitoring. As used in this disclosure, “continuous” does not necessarily connote uninterrupted, but instead can encompass situations characterized by repeated instances over an extended period of time. The method may also include transmitting a message if a temperature reading is outside a predetermined range. Transmitting a message may include transmitting an alarm, which may in certain embodiments encompass a visual or audible alarm. Transmitting a message may include sending a message to an e-mail address. The temperature monitor may be integral with the RFID tag.

In another respect, the invention involves a system including a temperature monitor, an RFID tag, and an RFID reader. The temperature monitor is in operative relationship with a refrigerator or heater. The RFID tag is configured to obtain and transmit temperature readings from within the refrigerator or heater using the temperature monitor. The RFID reader is configured to receive the temperature readings transmitted from the RFID tag and to transmit the temperature readings for monitoring as a function of time. The system can also include an electronic log configured to receive and record the temperature readings from the RFID reader. The RFID reader may be configured to transmit the temperature readings for continuous monitoring. The system may also include a messenger configured to transmit a message if a temperature reading is outside a predetermined range. The messenger may be configured to transmit an alarm. The messenger may be configured to transmit an e-mail message to an e-mail address. The system may also include a protective covering configured to protect the RFID tag from substances inside the refrigerator or heater through at least partial enclosure. The temperature monitor may be integral with the RFID tag.

In another respect, the invention involves a method for tracking and monitoring a patient and healthcare provider. The patient and healthcare provider are equipped with RFID tags. A healthcare facility is equipped with a plurality of RFID readers. The patient and healthcare provider are tracked and monitored using the RFID tags and RFID readers. The tracking and monitoring may include continuous bedside verification of the patient. The tracking and monitoring may include remote monitoring of a location of the patient. The remote monitoring may include classifying the location of the patient as in-room or out-of-room. The tracking and monitoring may include monitoring a time the healthcare provider is at a location within the healthcare facility. The location may include an examining room, and the method may also include measuring productivity using the time the healthcare provider is within the examining room. The tracking and monitoring may include monitoring a transit time for the healthcare provider going from one location to another within the healthcare facility. The method may also include equipping supplies and equipment associated with the patient with RFID tags and correlating the supplies and equipment with the patient independent of an admitting, discharge, and transfer (ADT) system.

In another respect, the invention involves a method for tracking and monitoring a visitor within a healthcare facility. The visitor is equipped with an RFID tag. An area of the healthcare facility is identified as an unauthorized area to the visitor. The unauthorized area is equipped with an RFID reader. An alarm is triggered if the RFID reader indicates that the visitor has entered the unauthorized area. Different unauthorized areas may be identified for different visitors. The method may also include triggering an alarm if the visitor removes the RFID tag. The RFID tag may be reusable and re-programmable for different visitors.

In another respect, the invention involves a method for reducing medical error. Medication is equipped with an RFID tag programmed to correspond to a particular patient location. The patient location is equipped with an RFID reader. An alarm is triggered if the RFID reader detects tagged medication that does not correspond to the patient location. In other respects, the method may also include tracking and monitoring a patient and healthcare provider using the RFID reader.

In another respect, the invention involves a method for reducing medical error, in which medical equipment is equipped with RFID tags programmed to correspond to a particular procedure, a location to carry out the procedure is equipped with an RFID reader, and an alarm is triggered if the RFID reader detects tagged equipment that does not correspond to the procedure.

In another respect, the invention involves a method for time and motion analysis. A healthcare provider is equipped with an RFID tag. A healthcare facility is equipped with a plurality of RFID readers, and an activity rate of the healthcare provider is determined using the RFID tag and RFID readers. The activity rate may include a transit time, speed, a survey of locations visited, or time spent at a particular location. The method may also include equipping the healthcare facility with video cameras connected to the RFID readers and associating the activity rate with video footage. The video cameras may be connected to the RFID readers wirelessly. The method may also include connecting a database to the RFID readers to analyze activity rates.

In another respect, the invention involves a method of asset tracking and inventory maintenance for healthcare providers. The location and identification of medical supplies are continuously monitored using RFID tags and readers, and the usage of the medical supplies is tracked according to different areas using the RFID tags and readers. Continuously monitoring may include monitoring more than twice per day. The method may also include calculating transit times for the medical supplies using the RFID tags and readers. The method may also include determining disease or procedure-specific units of medical supplies based on data from the RFID tags and readers. The method may also include modeling costs based on the data.

In another respect, the invention involves a method for monitoring medical equipment. Medical equipment is equipped with RFID tags. A dirty equipment location is equipped with a first RFID reader. A clean equipment location is equipped with a second RFID reader. “Clean” and “dirty” equipment locations are meant simply as labels to contrast different locations according to their containment of relatively clean and dirty equipment (e.g., equipment is “clean” if it is cleaner relative to the “dirty” equipment). Clean and dirty may refer to sterile or non-sterile in one embodiment. The amount of dirty and clean equipment is monitored based on data from the first and second RFID readers. The method may also include matching materials management personnel with workloads using the data. The method may also include generating productivity quality reports based on the data.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or method that “comprises,” “has,” or “includes” one or more elements or steps possesses those one or more elements or steps, but is not limited to possessing only those one or more elements or steps. Likewise, an element of an apparatus, or a step of a method, that “comprises,” “has,” or “includes” one or more features or steps, possesses those one or more features or steps, but is not limited to possessing only those one or more features or steps.

The term “coupled” means a direct or indirect connection and thus may encompass, among other types of connections, wired or wireless connections.

The terms “a” and “an” are defined as one or more than one unless this disclosure explicitly requires otherwise.

Techniques of the present disclosure may be carried out using software programmed to execute steps described herein. The software may be embodied on any computer readable medium including computer-executable instructions. The software may be written in any language or script known in the art including but not limited to C, C++, C#, JAVA, BASIC, PASCAL, FORTRAN, or the like. Instructions may be embodied as firmware on an integrated circuit (e.g., an application-specific integrated circuit, ASIC). Throughout this disclosure, if it is said that “one performs” a particular step, it shall be understood that such a step may be done by, or at least assisted by, a computing device running appropriate software.

Other features and associated advantages will become apparent with reference to the following detailed description of specific embodiments in connection with the accompanying drawings. The claims of this application take into account the breadth of the present invention.

### BRIEF DESCRIPTION OF THE DRAWINGS

The following drawings illustrate by way of example and not limitation. The use of identical reference numerals does not necessarily indicate an identical structure. Rather, the same reference numeral may be used to indicate a similar feature or a feature with similar functionality. Reference numerals should not be used to construe the claims.

FIG. 1 shows an example temperature monitoring system, according to an embodiment of the invention.

FIG. 2 is a close-up perspective view of a portion of a temperature monitoring system, according to an embodiment of the invention.

FIG. 3 is a flowchart showing example steps for temperature monitoring, according to an embodiment of the invention.

FIG. 4 is a flowchart showing example steps for tracking and monitoring a patient and healthcare provider, according to an embodiment of the invention.

FIG. 5 is a flowchart showing example steps for tracking and monitoring a visitor, according to an embodiment of the invention.

FIGS. 6-7 are flowcharts showing example steps for reducing medical error, according to embodiments of the invention.

FIG. 8 is a flowchart showing example steps for time and motion analysis, according to an embodiment of the invention.

FIG. 9 is a flowchart showing example steps for asset tracking and inventory maintenance, according to an embodiment of the invention.

FIG. 10 is a flowchart showing example steps for monitoring medical equipment, according to an embodiment of the invention.

### Description of Illustrative Embodiments

Embodiments of the present disclosure use RFID for various tasks. RFID technology itself (e.g., how to make and use RFID tags and their associated readers) is known in the art. For example, the reader is directed to the list of references at the end of this disclosure, each of which is incorporated by reference.

Temperature Monitoring

In one embodiment, refrigerator temperature monitoring can be drastically improved through the use of refrigerators equipped with RFID tags and facilities equipped with RFID readers.

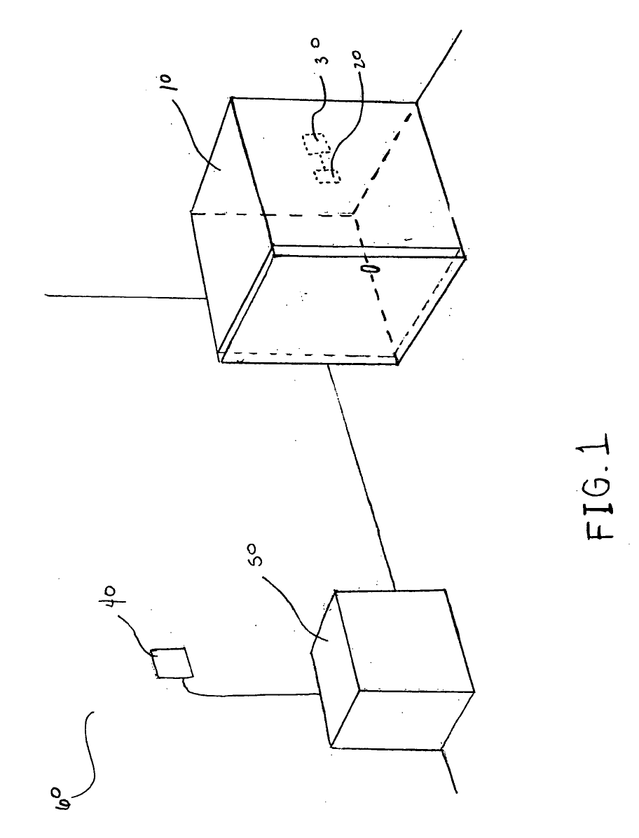

FIG. 1 shows an example system within facility 60 for monitoring the temperature inside a refrigerator or heater. Shown is a refrigerator 10, a temperature monitor 20 inside refrigerator 10, an RFID tag 30 configured to obtain and transmit temperature readings from temperature monitor 20, an RFID reader 40 configured to receive temperature readings transmitted from RFID tag 30, and electronic device 50 configured to receive information from RFID reader 40. Instead of a refrigerator 10 other embodiments may comprise a heater, which may also be represented by element 10 in FIG. 1.

RFID reader 40 may be placed anywhere, as long as the location allows the RFID reader to obtain temperature readings from RFID tag 30. Both the temperature monitor 20 and the RFID tag 30 may be placed inside refrigerator 10 (this is indicated by the dotted lines that illustrate these items). However, in other embodiments, this may not necessarily be the case. As long as temperature monitor 20 is able to monitor the temperature inside refrigerator 10, and as long as RFID tag 30 is configured to obtain and transmit temperature readings from temperature monitor 20, their location may be inside or outside refrigerator 10. In addition, while one of them may be inside refrigerator 10 the other may be outside.

In the embodiment shown in FIG. 1, RFID tag 30 is shown connected to temperature monitor 20, as illustrated by the dotted line between them. In other embodiments however, this may not necessarily be the case. For example, in some embodiments, temperature monitor 20 and RFID tag 30 may be integral with each other. In other embodiments, although not integral with each other, RFID tag 30 may be configured to obtain temperature readings from temperature monitor 20 wirelessly.

FIG. 1 illustrates RFID reader 40 connected to electronic device 50, as indicated by the line between them. This connection allows RFID reader 40 to transmit temperature readings to electronic device 50. In other embodiments, the connection may be a wireless connection, while still in other embodiments, electronic device 50 may be integral with the RFID reader 40. In the embodiment of FIG. 1, RFID reader 40 is outside refrigerator 10; however, in other embodiments RFID reader 40 may be inside refrigerator 10.

RFID reader 40 may be configured to obtain temperature readings from RFID tag 30 and to transmit temperature readings to electronic device 50 once per day, multiple times per day, or continuously (e.g., repeatedly with short or no time interval in between transmissions). Electronic device 50 may be configured to record temperature readings received from RFID reader 40. These temperature readings may be recorded in an electronic log, which may be embodied by a database, a computer system, a personal digital assistant (PDA), a cell phone, and/or any other appropriate medium for recording information electronically (e.g., a hard drive, CD, tape, FLASH memory device, etc.). Electronic device 50 may also, or instead, be configured to send a message if a temperature reading received by RFID reader 40 is outside a predetermined range. In such an embodiment, electronic device 50 may be termed a “messenger.” The message sent may be an alarm, audible and/or visible, and/or any other appropriate message that warns of a temperature being outside a desired range. The message may also, or instead, be sent to an e-mail address, or any other appropriate medium for receiving such a message (e.g., a telephone message, a message to a pager, a message to a workstation, and/or a message to any other appropriate electronic medium).

Electronic device 50 may send a message not only when the temperature reading received is outside a predetermined range, but also in other occasions to report things like temperature readings, temperature trends, temperature parameters and thresholds (e.g., the time period between subsequent temperature readings or the acceptable temperature thresholds), location or identity of refrigerator/heater from which temperature was read, and/or any other related information. A message may also, or instead, include the amount of time that has passed during which a temperature reading has been outside an acceptable range.

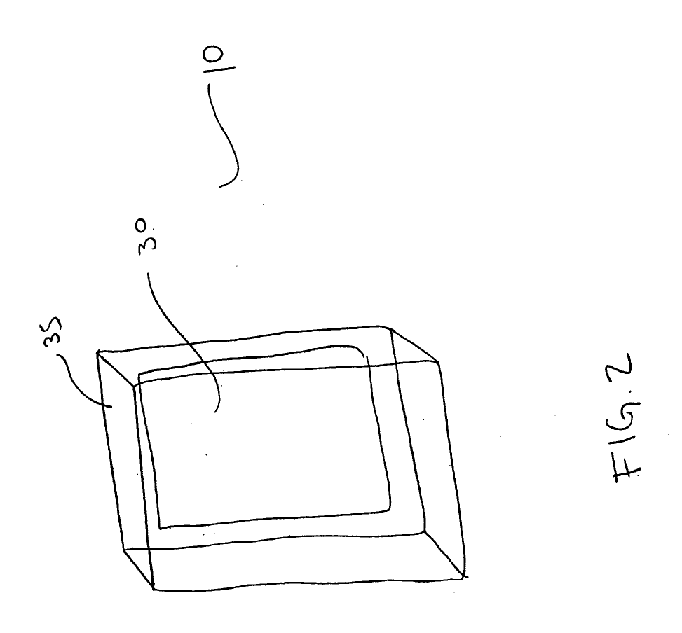

FIG. 2 shows a close-up perspective view of an embodiment comprising an RFID tag 30 inside a refrigerator 10, the RFID tag 30 having a protective covering 35. Protective covering 35 may be configured to enclose and protect the RFID tag from substances inside the refrigerator. Other elements may be inside refrigerator 10, like for example a temperature monitor, but are omitted in FIG. 2 for clarity. Protective covering 35 shown in the embodiment of FIG. 2 completely encloses RFID tag 30. However in other embodiments, protective covering 35 may only partially enclose RFID tag 30, as long as it is sufficient to protect RFID tag 30 from substances inside refrigerator 10.

As previously noted, RFID tag 30 may be placed inside or outside a refrigerator. If placed outside a refrigerator, protective covering 35 may be configured to enclose and protect RFID tag 30 from substances outside the refrigerator. The shape and size of, and materials for, protective covering 35 may vary in different embodiments. For instance, materials having different heat conductivity may be used.

In one embodiment, a refrigerator contains a temperature monitor with a thermometer associated with it. The temperature monitor may be located along a back interior wall of the refrigerator, away from shelves and products. Coupled to the temperature monitor may be an RFID tag. At a distance between about 1 inch to about 250 feet, an RFID reader may be located. Other distances sufficient to allow for the transfer of information between the RFID tag and reader may be used. The reader may be wall mounted, flush with the wall. Coupled to the reader may be a control server or other computing device. The control server may be coupled to a remote workstation or other computing device. The remote workstation may be used for monitoring and/or reporting of information transmitted from the RFID tag to the RFID reader. Software running on, or accessible by, the remote workstation may be configured to generate reports for an administration workstation, send alerts (e.g., to an alpha-numeric pager), send alerts to e-mail accounts, and/or send alerts to telephone numbers. The software may also be configured to generate and process reports. For example, raw data may be handled or organized. Trends in the data may be identified. Parameters or thresholds may be defined for data analysis. The software may also be configured for tracking purposes. For example, one may track scheduled maintenance associated with one or more RFID tags, track alerts, and track location and/or inventory information. Those having ordinary skill in the art will recognize that the software and the equipment described may be adapted to similar or additional uses, in accord with the knowledge in the art and the present disclosure.

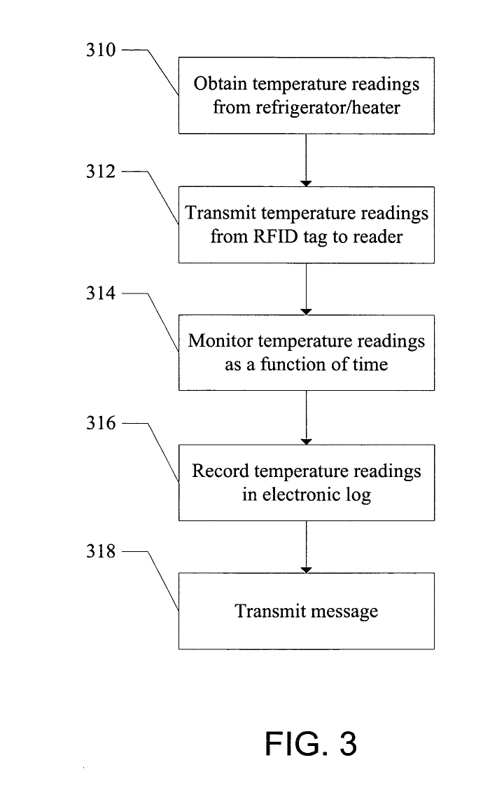

FIG. 3 is a flowchart showing example, non-limiting steps for monitoring temperature. In step 310, one obtains temperature readings from a refrigerator or heater. In preferred embodiments, this step may be accomplished using a temperature monitor including a thermometer located somewhere within the refrigerator or heater. In step 312, temperature readings are transmitted from an RFID tag (in communication with or integral with the temperature monitor) to an RFID reader. In step 314, one monitors the temperature readings as a function of time, which may be accomplished using a computer or other device. In step 316, temperature readings are stored in a electronic log, which may be a database or other appropriate medium. Along with the temperature readings, information such as trends may be stored. In step 318, a message is transmitted, which may be an alarm indicating a temperature out of acceptable limits or other message.

Utilization of temperature monitoring through RFID tags and RFID readers not only allows continual temperature verification but also remote and automatic temperature monitoring. In addition, temperature readings can be recorded automatically. For refrigerators used within medical settings, this facilitates complying with state regulations. Productivity of personnel may increase due to not having to manually check and record the temperature inside refrigerators. Furthermore, a system that utilizes RFID technology to monitor temperature facilitates notification of temperature readings when they are outside an acceptable range. Accuracy of the system is increased because one can monitor temperature on a more frequent basis. Besides being convenient, one reduces the likelihood that substances and items inside refrigerators will decompose or perish. Consequently, one decreases risks to persons exposed to these substances and/or items.

People Tracking and Monitoring

In one embodiment, people tracking and monitoring within a medical setting can be drastically improved through the use of patient ID bands equipped with RFID.

Patients and Providers

Utilization of patient tracking through patient ID bands equipped with RFID not only allows continual bedside verification of patient ID but also remote monitoring of patient location. This information is useful in a variety of ways. Patient location can be monitored by classifications such as in-room or out-of-room. In addition, productivity can be measured through data such as provider time in room. Transit times can be evaluated as a method of performance management process review. Finally, a system that utilizes RFID technology facilitates the correlation of supplies and equipment associated with each patient independent of an admitting, discharge, and transfer (ADT) system.

Visitors

The use of RFID technology for tracking and monitoring visitors to improve the current process of visitor identification through ID badges, stickers, etc. allows for much more than granting limited access. RFID facilitates the concept of an engaged system that does more than simply record events by quickly alerting security systems if a visitor badge enters an unauthorized area. Alternatively, specific visitors can be correlated with specific rooms or with specific patients improving overall security. In addition to this, badges using RFID technology can be equipped such that removal of a badge will result in an alert, notifying the security system that the badge has been deactivated which may be indicative of a potential event. Badges can be reusable and reprogrammable for each visitor. In a preferred embodiment, badges are inexpensive and are equipped with passive RFID tags.

Personnel

Personnel tracking and monitoring using RFID technology provides key functions not currently available to administrators and other healthcare providers. Rapid location of key individuals is one significant benefit of using RFID to track personnel. Another advantage involves the use of RFID in activity-based costing of care processes leading to improved financial accounting systems. Currently, information such as this is available only though limited time studies which are labor intensive and do not allow of continual reassessment to detect any decreases in efficiency.

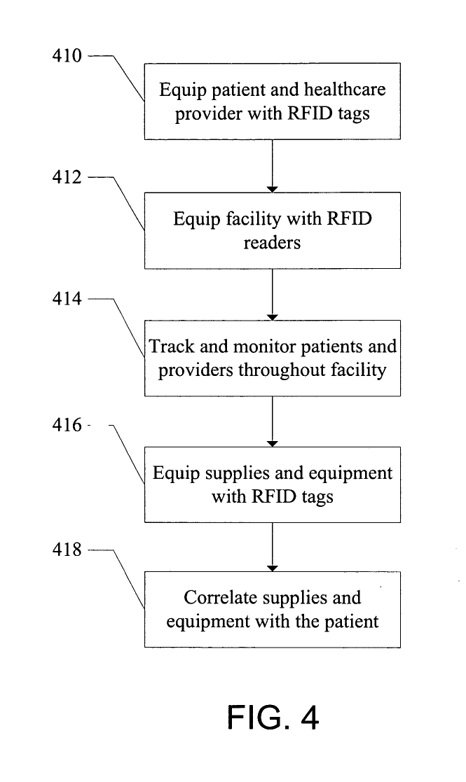

FIG. 4 is a flowchart showing example, non-limiting steps for tracking and monitoring a patient and healthcare provider. In step 410, a patient and healthcare provider are equipped with RFID tags. In step 412, a facility (e.g., a healthcare facility) is equipped with several RFID readers. In one embodiment, the readers may be distributed to provide a maximum area of coverage within the facility. In step 414, the patient and healthcare provider are tracked and monitored throughout the facility using the RFID tags and RFID readers. In one embodiment, such tracking and monitoring may include continuous bedside verification of the patient to ensure that particular patients remain in their bed and/or do not wander too far. Tracking and monitoring may be remote. Patients may be classified as in-room or out-of-room. One may monitor a time a particular healthcare provider is at a location within the healthcare facility (e.g., an examining room). One may correspondingly measure provider productivity by considering tasks accomplished compared to recorded times at corresponding locations. One may obtain a measure of transit efficiency by considering a transit time for the healthcare provider going from one location to another within the healthcare facility. In step 416, supplies and equipment associated with the patient are equipped with RFID tags. In step 418, one correlates the supplies and equipment with the patient (e.g., independent of an admitting, discharge, and transfer (ADT) system).

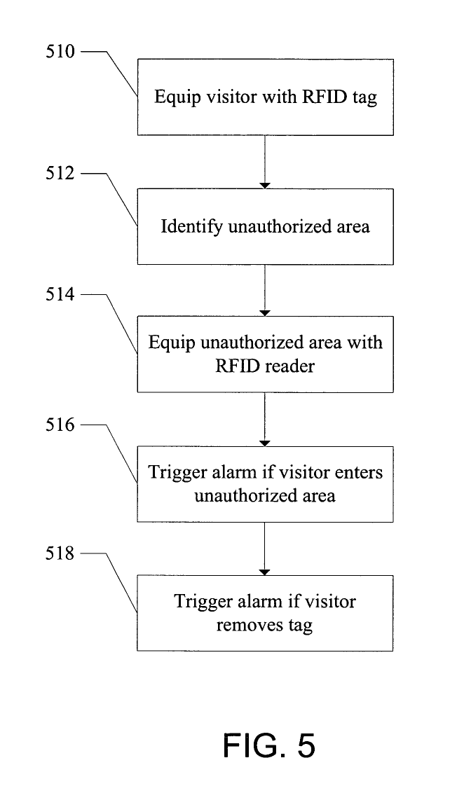

FIG. 5 is a flowchart showing example, non-limiting steps for tracking and monitoring a visitor within a facility (e.g. a healthcare facility). In step 510, a visitor is equipped with an RFID tag. In step 512, an area of a facility is identified as an unauthorized area to the visitor. In step 514, the unauthorized area is equipped with an RFID reader. In step 516, an alarm is triggered if the RFID reader indicates that the visitor has entered the unauthorized area. The alarm may be silent, audible, visual, textual, etc. In different embodiments, the alarm may include or consist of an e-mail, a pager to a pager, and/or a phone alert to a person such as a security officer. Different unauthorized areas may be identified for different visitors using the techniques of FIG. 5. In step 518, an alarm may be triggered if the visitor removes the RFID tag. For economy, RFID tags for visitors may be reusable and re-programmable. Accordingly, the RFID tags may be able to replacing traditional, temporary badges worn by hospital or other facility visitors.

Medical Error Reduction

In one embodiment, medical error reduction can be achieved by pairing RFID with medication administration.

An improvement to barcode systems comes with the addition of RFID technology including passive survey system technology. In one embodiment, drugs are tagged for specific patients such that if a drug enters any patient room other than the intended recipient, an alert will occur allowing all processes to be quickly reevaluated before the drug is administered to the patient. If used in an environment in which there is an adequate avenue for patient and personnel tracking, even more data can be harvested. Data on potential and actual events can be gathered and transit times from medication order entry to administration will be available.

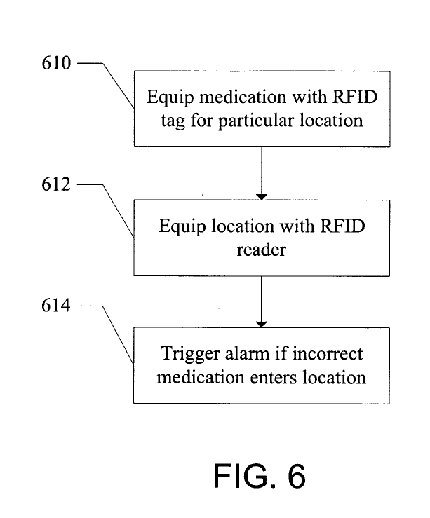

FIG. 6 is a flowchart showing example, non-limiting steps for medical error reduction. In step 610, medication is equipped with an RFID tag programmed to correspond to a particular patient location. For example, particular medication intended for a patient in room 101 may be tagged so that room 101 is indicated. In step 612, the patient location (e.g., room 101 in this example) is equipped with an RFID reader. In step 614, an alarm is triggered if the RFID reader detects tagged medication that does not correspond to the patient location (e.g., an audible, silent, visual, or messaging alarm is triggered if medication tagged for room 102 enters room 101).

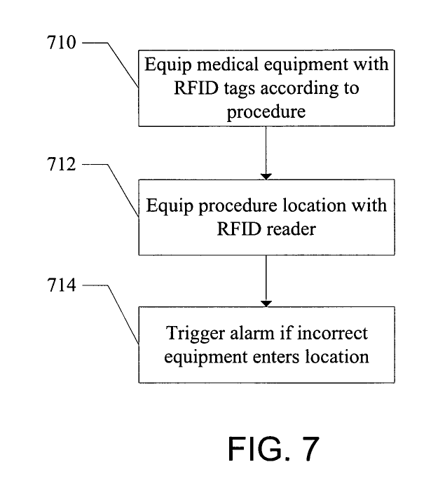

FIG. 7 is another flowchart showing example, non-limiting steps for medical error reduction. In step 710, medical equipment is equipped with RFID tags programmed to correspond to a particular procedure. For example, a particular type of stent may be tagged for a heart surgery taking place in a particular operating room. In step 712, a location to carry out the procedure is equipped with an RFID reader. In this example, the operating room for the heart/stent procedure is equipped with a reader. In step 714, an alarm is triggered if the RFID reader detects tagged equipment that does not correspond to the procedure (e.g., an audible, silent, visual, or messaging alarm is triggered if a different stent, tagged for a different procedure, enters the operating room).

Time and Motion Analyses

In one embodiment, time and motion analyses can be achieved by creating easily deployable RFID which utilizes local wireless connectivity between, e.g., readers, cameras, and active tags to create a tool kit for time and motion studies in almost any environment.

In one embodiment, time and motion analyses is achieved through creation of a tool in which a database is linked with readers and tags such as active tags. The tool is easily deployed by relatively novice individuals and provides an improved system for process evaluation. In a preferred embodiment, the database should be easily defined by end users and have the ability to incorporate wireless cameras which can be easily deployed to add visual data to the database.

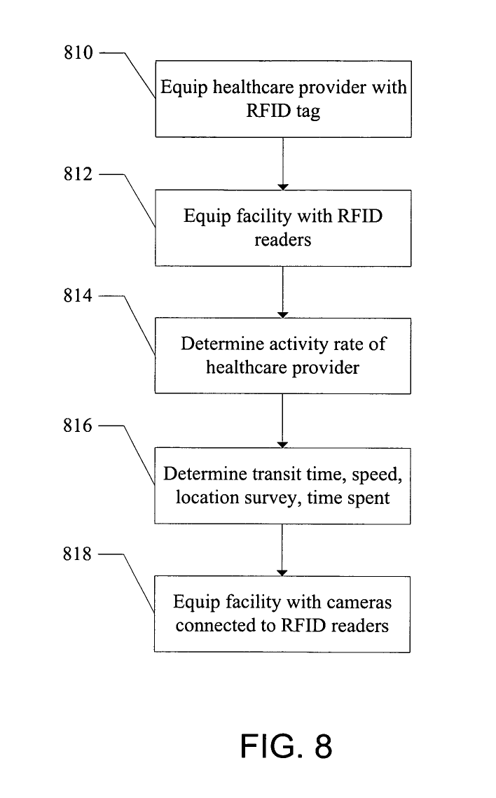

FIG. 8 is flowchart showing example, non-limiting steps for time and motion analysis. In step 810, a healthcare provider is equipped with an RFID tag. In step 812, a healthcare facility is equipped with several RFID readers. In step 814, an activity rate of the healthcare provider is determined using the RFID tag and RFID readers. The activity rate may encompass several different types of measurements, each involving a determination of time-dependent provider activity. In step 816, example activity rate determinations are indicated. For example, one may determine a transit time, speed, a survey of locations visited, or time spent at a particular location. In step 818, the healthcare facility is also equipped with video cameras connected to the RFID readers. This allows one to associate particular activity with video footage. For example, if an activity rate for a particular provider is especially low, one may review video footage to determine the cause. Video cameras may be connected to the RFID readers wirelessly. Suitable electronic devices (e.g., a database, personal computer, etc.) may store and analyze activity rates. Such devices may also automatically store associated video footage.

Asset Tracking and Inventory Maintenance

RFID, unlike traditional barcode systems, offers continual monitoring of location and identification of supplies as well as usage area tracking. The abilities of RFID technology create a seamless process transition from stocking, to distribution, to use. The byproduct of such a comprehensive tracking process is the capture of transmission times allowing for the assessment of quality on many different levels: increased accuracy of both provider and patient usage and improved charge capture. Through a non-labor reliant system of tracking items, disease or program specific units of chargeable supplies can be developed.

In a preferred embodiment, the equipment used in an RFID system is reusable, which allows monitoring or tracking of the location of hard to find items, making those items easily discoverable. This results in decreased frustration of the bedside users as they will no longer have to search for items. Unique unit specific data leads to accurate logs or files with up-to-date information on location of assets resulting in reduced FTE or manpower needs for mundane processes.

In one embodiment, RFID tracking and monitoring systems allow users to accurately acquire data regarding the states in which equipment resides (dirty, clean, ready to restock, in use, etc.) resulting in improved matching of materials management personnel with workloads and ultimately, the ability to generate productivity quality reports giving the organization more clearly defined opportunities for improvement.

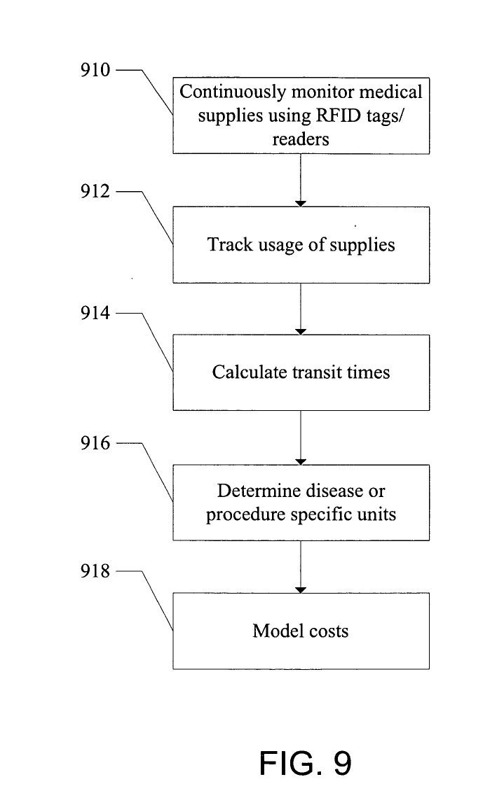

FIG. 9 is flowchart showing example, non-limiting steps for asset tracking and inventory maintenance. In step 910, the location and identification of medical supplies are continuously monitored using RFID tags and readers. Such monitoring may be done with a very short, or no, interval between measurement cycles. For example, in one embodiment, supplies are monitored every few seconds. In other embodiments, supplies may be monitored every few minutes, hours, days, weeks, etc. In other embodiments, supplies may be monitored without any interruption. In step 912, the usage of the medical supplies is tracked according to different areas using the RFID tags and readers. For example, one may log what supplies have been used in particular areas as a function of time. In step 914, one calculates calculating transit times for the medical supplies using the RFID tags and readers. For example, if a stent is read in a supply room at noon and then at an operating room at 12:30 p.m., one may calculate a transit time of 30 minutes. Knowing the distance between the supply and operating rooms allows one to calculate a transit speed. In step 916, one may determine disease or procedure-specific units of medical supplies based on data from the RFID tags and readers. For example, one may keep statistics about usage of particular types of stents. In step 918, one models costs based on RFID reader data. For example, if one knows the costs of stents and the data shows that a particular number of stents are being used per month, one may use that information to model future or current costs.

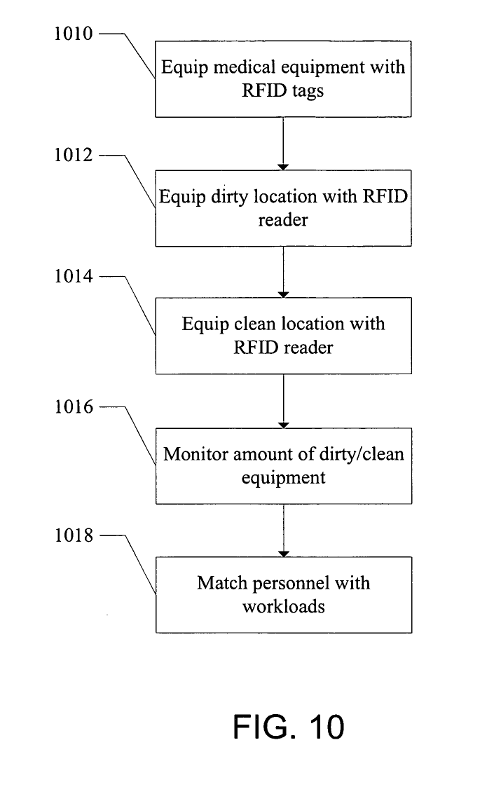

FIG. 10 is another flowchart showing example, non-limiting steps for asset tracking and inventory maintenance—in this case, medical equipment is monitored. In step 1010, medical equipment is equipped with RFID tags. In step 1012, a “dirty” equipment location is equipped with a first RFID reader. As noted earlier, “dirty” is a relative label that contrasts one location from another based on sterility of associated equipment or other measure of cleanliness. In step 1014, a “clean” equipment location is equipped with a second RFID reader. In step 1016, the amount of dirty and clean equipment is monitored based on data from the first and second RFID readers. For example, one may monitor how much clean equipment enters a particular location and, alternatively, whether any clean or dirty equipment enters the wrong location (e.g., whether any dirty equipment enters an area meant for sterile equipment). In step 1018, one may match materials management personnel with workloads using the data. For example, if data shows high activity associated with a particular location, personnel may be assigned to those locations.

It should be understood that the techniques described here are not intended to be limited to the specific embodiments disclosed. Rather, they are to cover all modifications, equivalents, and alternatives falling within the scope of the claims. Furthermore, the claims are not to be interpreted as included means-plus- or step-plus-function limitations, unless such a limitation is explicitly recited in a given claim using the phrases(s) “means for” or “step for,” respectively.

The following examples are included to demonstrate additional, specific embodiments of this disclosure.

### EXAMPLES

The techniques disclosed here allow one to implement a number of useful systems. Additional examples (some of which overlap with systems described above) include, but are not limited to:
(a) inventory tracking and theft control for patient belongings (examples include dentures, jewelry, cash);
(b) security mapping of patient with family with care team to facility location;
(c) productivity measurement of health care professionals;
(d) passive surveillance of hospital equipment and supply;
(e) real time reading and historical mapping of hospital equipment movement;
(f) patient identification and electronic medical record data points within a tamperproof armband device that interfaces with clinical systems;
(g) patient identification and location tracking within a tamperproof armband device the triggers security systems when at/beyond set parameters;
(h) hospital visitor security tags that assign visitors to authorized locations within a medical campus and triggers security when at/beyond set parameters;
(i) active surveillance and correlation of medication to patient to prevent adverse drug events;
(j) passive surveillance of medicine within defined hospital location triggering security, inventory and charge capture systems;
(k) portable time and motion study kit for measuring and reporting process time cycles and workforce productivity analysis;
(1) notification and alarm messaging to appropriate parties when set parameters for biomedical equipment usage, maintenance, and/or settings are compromised; and
(m) implantable device used with portable reader to measure and report biostatistics of patient to hospital. Example: medication absorption to determine if child in high risk home environment receives medications.

### REFERENCES

Each of the following references is incorporated by reference in its entirety into this disclosure:
U.S. Pat. No. 6,669,089
U.S. Pat. No. 6,664,897
U.S. Pat. No. 6,621,417
U.S. Pat. No. 6,608,551
U.S. Pat. No. 6,600,418
U.S. Pat. No. 6,557,758
U.S. Pat. No. 6,536,660
U.S. Pat. No. 6,535,129
U.S. Pat. No. 6,510,984
U.S. Pat. No. 6,507,279
U.S. Pat. No. 6,427,913
U.S. Pat. No. 6,407,665
U.S. Pat. No. 6,360,208
U.S. Pat. No. 6,342,839
U.S. Pat. No. 6,267,291
U.S. Pat. No. 6,263,440
U.S. Pat. No. 6,249,227
U.S. Pat. No. 6,204,764
U.S. Pat. No. 6,170,059
U.S. Pat. No. 6,154,790
U.S. Pat. No. 6,144,301
U.S. Pat. No. 5,973,600
U.S. Pat. No. 5,910,776

1. A method for monitoring the temperature inside a refrigerator or heater, comprising:
obtaining temperature readings from within a refrigerator or heater using a temperature monitor;
transmitting the temperature readings from a (RFID) tag to an RFID reader; and
monitoring the temperature readings received by the RFID reader as a function of time.

2. The method of claim 1, where monitoring comprises recording temperature readings in an electronic log.

3. The method of claim 1, where monitoring comprises continuous monitoring.

4. The method of claim 1, further comprising transmitting a message if a temperature reading is outside a predetermined range.

5. The method of claim 4, where transmitting a message comprises transmitting an alarm.

6. The method of claim 4, where transmitting a message comprises sending a message to an e-mail address.

7. The method of claim 1, where the temperature monitor is integral with the RFID tag.

8. A system comprising:
a temperature monitor in operative relationship with a refrigerator or heater;
a radio frequency identification (RFID) tag, the RFID tag configured to obtain and transmit temperature readings from within the refrigerator or heater using the temperature monitor; and
an RFID reader, the RFID reader configured to receive the temperature readings transmitted from the RFID tag and to transmit the temperature readings for monitoring as a function of time.

9. The system of claim 8, further comprising an electronic log configured to receive and record the temperature readings from the RFID reader.

10. The system of claim 8, where the RFID reader is configured to transmit the temperature readings for continuous monitoring.

11. The system of claim 8, further comprising a messenger configured to transmit a message if a temperature reading is outside a predetermined range.

12. The system of claim 11, where the messenger is configured to transmit an alarm.

13. The method of claim 11, where the messenger is configured to transmit an e-mail message to an e-mail address.

14. The system of claim 8, further comprising a protective covering configured to protect the RFID tag from substances inside the refrigerator or heater through at least partial enclosure.

15. The system of claim 8, where the temperature monitor is integral with the RFID tag.

16. A method for tracking and monitoring a patient and healthcare provider, comprising:
equipping the patient and healthcare provider with radio frequency identification (RFID) tags;
equipping a healthcare facility with a plurality of RFID readers; and
tracking and monitoring the patient and healthcare provider using the RFID tags and RFID readers.

17. The method of claim 16, where the tracking and monitoring comprise continuous bedside verification of the patient.

18. The method of claim 16, where the tracking and monitoring comprise remote monitoring of a location of the patient.

19. The method of claim 18, where the remote monitoring comprises classifying the location of the patient as in-room or out-of-room.

20. The method of claim 16, where the tracking and monitoring comprise monitoring a time the healthcare provider is at a location within the healthcare facility.

21. The method of claim 20, where the location comprises an examining room and further comprising measuring productivity using the time the healthcare provider is within the examining room.

22. The method of claim 16, where the tracking and monitoring comprise monitoring a transit time for the healthcare provider going from one location to another within the healthcare facility.

23. The method of claim 16, further comprising:
equipping supplies and equipment associated with the patient with RFID tags; and
correlating the supplies and equipment with the patient independent of an admitting, discharge, and transfer (ADT) system.

24. A method for tracking and monitoring a visitor within a healthcare facility, comprising:
equipping the visitor with a radio frequency identification (RFID) tag;
identifying an area of the healthcare facility as an unauthorized area to the visitor;
equipping the unauthorized area with an RFID reader; and
triggering an alarm if the RFID reader indicates that the visitor has entered the unauthorized area.

25. The method of claim 24, where different unauthorized areas are identified for different visitors.

26. The method of claim 24, further comprising triggering an alarm if the visitor removes the RFID tag.

27. The method of claim 26, the RFID tag being reusable and re-programmable for different visitors.

28. A method for reducing medical error, comprising:
equipping medication with a radio frequency identification (RFID) tag programmed to correspond to a particular patient location;
equipping the patient location with an RFID reader; and
triggering an alarm if the RFID reader detects tagged medication that does not correspond to the patient location.

29. The method of claim 28, further comprising tracking and monitoring a patient and healthcare provider using the RFID reader.

30. A method for reducing medical error, comprising:
equipping medical equipment with radio frequency identification (RFID) tags programmed to correspond to a particular procedure;
equipping a location to carry out the procedure with an RFID reader; and
triggering an alarm if the RFID reader detects tagged equipment that does not correspond to the procedure.

31. A method for time and motion analysis, comprising:
equipping a healthcare provider with a radio frequency identification (RFID) tag;
equipping a healthcare facility with a plurality of RFID readers; and
determining an activity rate of the healthcare provider using the RFID tag and RFID readers.

32. The method of claim 31, the activity rate comprising a transit time, speed, a survey of locations visited, or time spent at a particular location.

33. The method of claim 31, further comprising equipping the healthcare facility with video cameras connected to the RFID readers and associating the activity rate with video footage.

34. The method of claim 33, the video cameras being connected to the RFID readers wirelessly.

35. The method of claim 31, further comprising connecting a database to the RFID readers to analyze activity rates.

36. A method of asset tracking and inventory maintenance for healthcare providers, comprising:
continuously monitoring location and identification of medical supplies using radio frequency identification (RFID) tags and readers; and
tracking usage of the medical supplies according to different areas using the RFID tags and readers.

37. The method of claim 36, where continuously monitoring comprises monitoring more than twice per day.

38. The method of claim 36, further comprising calculating transit times for the medical supplies using the RFID tags and readers.

39. The method of claim 36, further comprising determining disease or procedure-specific units of medical supplies based on data from the RFID tags and readers.

40. The method of claim 39, further comprising modeling costs based on the data.

41. A method for monitoring medical equipment, comprising:
equipping medical equipment with radio frequency identification (RFID) tags;
equipping a dirty equipment location with a first RFID reader;
equipping a clean equipment location with a second RFID reader; and
monitoring the amount of dirty and clean equipment based on data from the first and second RFID readers.

42. The method of claim 41, further comprising matching materials management personnel with workloads using the data.

43. The method of claim 41, further comprising generating productivity quality reports based on the data.
